(19) United States
(12) Patent Application Publication
(10) Pub. No.: US 2012/0097005 A1
(43) Pub. Date: Apr. 26, 2012

(54) Whirling cutting device

(75) Inventor: Hans-Joerg Braun, Hagen (DE)

(73) Assignee: REIKA GMBH & CO. KG, Hagen (DE)

(21) Appl. No.: 12/931,740

(22) Filed: Feb. 9, 2011

(30) Foreign Application Priority Data
Oct. 20, 2010 (EP) 10013795.9

(51) Int. Cl. B23D 45/08; B23D 61/08

(52) U.S. Cl. 83/483; 83/646; 83/663

(57) ABSTRACT

A whirling cutting device for use in flying saws has a tool accommodation and a ring-shaped whirling tool accommodated by it. The ring-shaped whirling tool is formed from at least two ring segments that have a positioning device on their side facing the tool accommodation. The positioning device on the ring segments corresponds with a positioning device disposed on the tool accommodation, thereby achieving centered placement of the ring segments relative to one another, as well as centering of the whirling tool in the tool accommodation. The positioning device can be in the form of an arc-shaped groove or ridge forming a circular segment.

### CROSS REFERENCE TO RELATED APPLICATIONS

Applicant claims priority under 35 U.S.C. 119 of European Application No. EP 10013795.9 filed Oct. 20, 2010.

### BACKGROUND OF THE INVENTION

1. Field of the Invention

The invention relates to a whirling cutting device for use in flying saws, and in particular to a ring-shaped whirling tool for use in such a device.

2. The Prior Art

The whirling method is a chip-removing method in which the tool circles around the work piece in the manner of a spiral whirl. The cutting depth is produced in a single work step, by one or more blades that revolve at a high cutting speed. In this connection, the inner mantle surface formed by the cutting tool rolls on the cylindrical outer mantle surface of the work piece to be machined. The constantly circulating movement of the cutting tool is superimposed in this movement process.

The whirling method, which is described in European Patent No. EP 0 490 328 B1, has the advantage that a plurality of cutting tools, particularly cutting steels, can be disposed next to one another, engaging the work piece at the same time, over a larger segment range. During whirling cutting, a whirling saw tool with teeth that lie on the inside—subsumed in the concept of “saw blade” hereinafter—is used. The cutting teeth of the saw blade can penetrate into the work piece tangentially. Because of the whirling method, the effective penetration radius of the saw blade only has to comprise the wall thickness of the work piece. If this is a solid material, the saw blade only has to penetrate to the center point of the solid material, since the other half of the work piece is cut off by the revolution of the saw blade. Use of the whirling method for cutting work pieces in the form of pipes and rods reduces the machining times.

In order to cut pipe sections that are longitudinally welded to length, which sections are theoretically endless, so-called flying saws are used, which are synchronized with the advance of the pipe section and undertake the cutting process in accordance with the advance of the pipe section. Such a flying saw is described in German Patent Application No. DE 31 12 519 A1, for example.

When a flying saw is configured as a whirling sawing device, having a saw blade with teeth that lie on the inside, the problem arises that the closed ring tool cannot be easily removed during an unplanned tool change without first cutting the pipe.

### SUMMARY OF THE INVENTION

It is therefore an object of the invention to provide a whirling cutting device for use with flying saws, which allows an unplanned tool change without previously cutting the pipe. According to the invention, this object is accomplished by a whirling cutting device comprising a tool accommodation and a ring-shaped whirling tool accommodated by it. The ring-shaped whirling tool is formed from at least two ring segments which are provided with a positioning device on their side facing the tool accommodation. The positioning device corresponds with a positioning device disposed on the tool accommodation, thereby achieving centered placement of the ring segments relative to one another, as well as centering of the whirling tool in the tool accommodation.

With the invention, a whirling cutting device for use with flying saws is created, which allows an unplanned tool change without previously cutting the pipe. By configuring the whirling tool from at least two ring segments, partial removal of the ring segments is made possible. The closed arrangement of the at least two ring segments in the form of a ring-shaped tool having teeth that lie on the inside is made possible by the positioning device provided on the ring segments, which corresponds with a positioning device disposed on the tool accommodation.

In a further development of the invention, the positioning device disposed on the ring segments is formed by an arc-shaped groove, and the positioning device of the tool accommodation has an arc-shaped ridge that corresponds to the arc-shaped groove. In this way, procedurally safe, simple, position-determined positioning of the ring segments is made possible. The same holds true in the case of the placement of the arc-shaped ridge on the ring segments, whereby the positioning device of the tool accommodation has a groove that corresponds with the arc-shaped ridge.

In a further embodiment of the invention, the arc-shaped groove of the ring segments is configured in the shape of a circular arc, so that a circular circumferential groove is formed by the grooves of the ring segments, in the assembled state. The arc-shaped ridge of the tool accommodation is configured in the shape of a circumferential circular arc. In this way, simple positioning of the ring segments is achieved.

Preferably, the grooves as well as the ridges have a cross-section in the shape of a symmetrical trapezoid. In this way, introduction of the arc-shaped ridges into the corresponding groove is facilitated.

In a further embodiment of the invention, the at least two ring segments each have at least one chip chamber for removal of chips. In this way, orderly removal of the chips is brought about, thereby achieving a cleaner cut.

In a further development of the invention, the at least two ring segments are additionally provided with a positioning device on their side facing away from the tool accommodation, whereby a handling module for centered installation of the ring segments on the tool accommodation is provided, which module has a positioning device that corresponds with the positioning device of the ring segments, thereby guaranteeing centered placement of the ring segments relative to one another. In this way, partly automatic or even automatic equipping of the device with ring segments is made possible.

It is advantageous if the additional positioning device disposed on the ring segments is formed by an arc-shaped groove introduced into the side of the ring segments facing away from the tool accommodation, or an arc-shaped ridge disposed on that side. In this connection, the arc-shaped groove or the arc-shaped ridge of the ring segments is preferably configured in the shape of a circular arc, so that a circular circumferential groove or a circular circumferential ridge is formed by the grooves or the ridges, respectively, of the ring segments, in the assembled state. The additional arc-shaped groove or the additionally provided arc-shaped ridge preferably has a cross-section in the shape of a symmetrical trapezoid.

The present invention also comprises a ring-shaped whirling tool for use in a device of the aforementioned type, which tool allows an unplanned tool change without previous cutting of the pipe. The whirling tool comprises at least two ring segments that have a positioning device in the form of an arc-shaped groove, in the manner of a circular arc, or an arc-shaped ridge in the manner of a circular arc, on at least one side.

In a further development of the invention, the grooves as well as the ridges have a cross-section in the shape of a symmetrical trapezoid. In this way, positioning of the ring segments of the ring-shaped whirling tool on the tool accommodation, in the correct position, is facilitated.

The invention also comprises a flying or stationary saw for cutting rod or pipe material to length, using a whirling cutting device of the aforementioned type.

### BRIEF DESCRIPTION OF THE DRAWINGS

Other objects and features of the present invention will become apparent from the following detailed description considered in connection with the accompanying drawings. It is to be understood, however, that the drawings are designed as an illustration only and not as a definition of the limits of the invention.

In the drawings, wherein similar reference characters denote similar elements throughout the several views:

FIG. 1 shows a schematic representation of a ring-shaped whirling tool according to one embodiment of the invention; and

FIG. 2 shows a schematic representation of a tool accommodation for accommodating the whirling tool shown in FIG. 1.

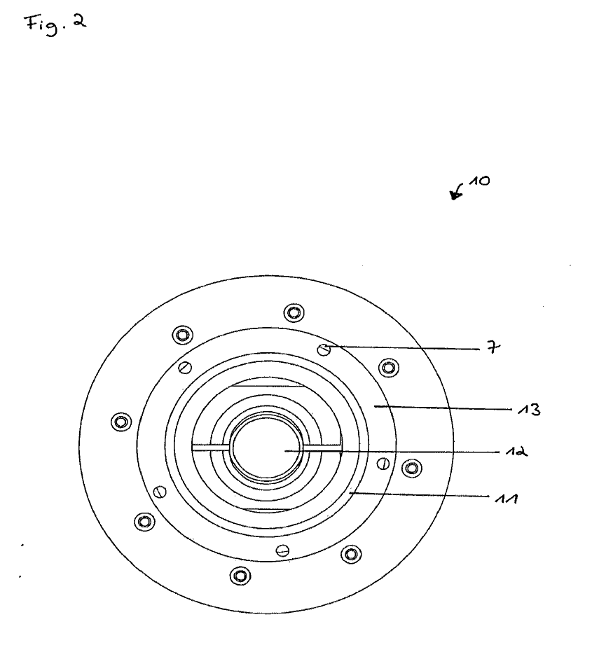

### DETAILED DESCRIPTION OF THE PREFERRED EMBODIMENT

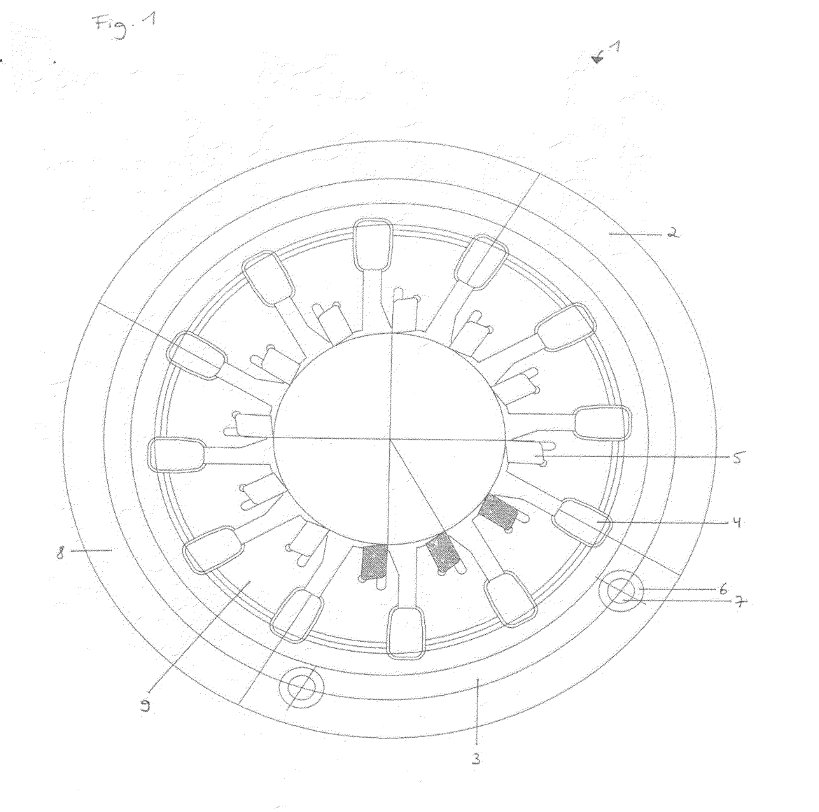

Referring now in detail to the drawings, the device shown in FIG. 1 essentially consists of a tool accommodation 10 as well as a ring-shaped whirling tool 1 accommodated by it. The tool accommodation 10 is essentially configured in the shape of a funnel. This formation has an advantageous effect on the chip removal. Around the circumference of its circular opening 12, a contact flange 13 for fit-precise contact of a whirling tool 1 is disposed in tool accommodation 10. For a defined position of whirling tool 1, contact flange 13 is provided with a circumferential, circular ridge 11. At a distance from circular circumferential ridge 11, fixation pins 7 are furthermore disposed, which engage into bores 6 of whirling tool 1 and fix whirling tool 1 in place axially. Tool accommodation 10 is connected with a whirling unit having a rotational drive, within a flying saw.

In the exemplary embodiment, whirling tool 1 is configured in the manner of a saw blade having teeth on the inside. It essentially consists of a ring body 8 that is delimited on the inside by means of a blade carrier ring 9, which accommodates blades 5. A chip chamber 4 directed radially outward is disposed between each of blades 5. Whirling tool 1 is composed of four ring segments 2, each of which is provided with a groove 3 in the shape of a circular arc. Grooves 3 are configured in such a manner that they form a circumferential circular groove in the assembled state of whirling tool 1. Grooves 3 of ring segments 2 have a cross-section in the shape of a symmetrical trapezoid. Corresponding to this, the circular-arc-shaped circumferential ridge 11 of tool accommodation 10 also has a cross-section in the shape of a symmetrical trapezoid. The parting edges of ring segments 2 are configured in such a manner that they do not lie on a line with a parting edge of another ring segment 2 in the assembled state. In this connection, the parting edges are passed through the center of a chip chamber 4, in each instance.

Ring segments 2 are provided with bores 6 for accommodating fixation pins 7 of tool accommodation 10.

Accordingly, while only a few embodiments of the present invention have been shown and described, it is obvious that many changes and modifications may be made thereunto without departing from the spirit and scope of the invention.

What is claimed is:

1. A whirling cutting device for use in flying saws, comprising:
a tool accommodation having a positioning device; and
a ring-shaped whirling tool accommodated by the tool accommodation, said ring shaped whirling tool being formed from at least two ring segments, which are provided with a positioning device on a side facing the tool accommodation,
wherein said positioning device of the whirling tool corresponds with the positioning device of the tool accommodation, to achieve centered placement of the ring segments relative to one another, as well as centering of the whirling tool in the tool accommodation.

2. The device according to claim 1, wherein the positioning device disposed on the ring segments is formed by an arc-shaped groove, on each of the ring segments, and the positioning device of the tool accommodation has an arc-shaped ridge that corresponds to the arc-shaped groove.

3. The device according to claim 1, wherein the positioning device disposed on the ring segments is formed by an arc-shaped ridge, on each of the ring segments, and the positioning device of the tool accommodation has an arc-shaped groove that corresponds to the arc-shaped ridge.

4. The device according to claim 2, wherein the arc-shaped groove of the ring segments is configured in the shape of a circular arc, in such a manner that a circular circumferential groove is formed by the grooves of the ring segments, in an assembled state, and wherein the arc-shaped ridge of the tool accommodation is configured in the shape of a circumferential circular arc.

5. The device according to claim 1, wherein the whirling tool is a whirling saw.

6. The device according to claim 1, wherein the at least two ring segments each have at least one chip chamber for chip removal.

7. A ring-shaped whirling tool for use in a whirling cutting device having a tool accommodation, the tool comprising:
at least two ring segments that each have a positioning device in the form of an arc-shaped groove, in the manner of a circular arc, or an arc-shaped ridge in the manner of a circular arc, on at least one side.

8. A flying or stationary saw for cutting rod or pipe material to length, having a whirling cutting device comprising:
a tool accommodation having a positioning device; and
a ring-shaped whirling tool accommodated by the tool accommodation, said ring shaped whirling tool being formed from at least two ring segments, which are provided with a positioning device on a side facing the tool accommodation,
wherein said positioning device of the whirling tool corresponds with the positioning device of the tool accommodation, to achieve centered placement of the ring segments relative to one another, as well as centering of the whirling tool in the tool accommodation.
